(19) United States
(12) Patent Application Publication
(10) Pub. No.: US 2007/0073685 A1
(43) Pub. Date: Mar. 29, 2007

(54) Systems and methods for valuing receivables

(75) Inventors: Robert Thibodeau, Gloucester, MA (US); Thomas D. Halket, Larchmont, NY (US)

Correspondence Address: LAHIVE & COCKFIELD, LLP, ONE POST OFFICE SQUARE, BOSTON, MA, 02109-2127, US

(73) Assignee: Robert Thibodeau, Gloucester, MA (US)

(21) Appl. No.: 11/236,296

(22) Filed: Sep. 26, 2005

(51) Int. Cl. G06F 17/30

(52) U.S. Cl. 707/6

(57) ABSTRACT

The present invention provides systems and methods for processing receivables data, such as medical receivables, to provide the receivables as an asset with a qualified financial value for a financial services domain. The medical receivables data may include an identifier of a health care related service for which a claim for payment is requested. The present invention describes systems and methods for assigning a predictive financial value for the service identified by the claim to create an asset with a qualified financial value and to create an agreement or financial instrument to pay the qualified financial value by a payer.

### TECHNICAL FIELD

The present invention generally relates to securely processing receivables data to provide financial services data.

### BACKGROUND INFORMATION

Numerous laws and regulations affect the privacy of personal information. For example, the United States government has enacted multiple Acts mandating privacy of personal information, such as the Health Insurance Portability and Accountability Act of 1996, referred to as HIPAA, and The Financial Modernization Act of 1999, also known as the “Gramm-Leach-Bliley Act” or GLB Act. HIPAA sets a national standard for electronic transfers of personal health and medical information data. The GLB Act governs the collection and disclosure of customers' personal financial information by financial institutions, and also applies to other types of companies who receive such information. In another example, the European Union enacted a Directive, referred to as the Data Directive, which imposes strict requirements on the collection, use and disclosure of personal data by businesses in the European Union. Additionally, the Data Directive states that these businesses may not transfer data outside the European Union unless the recipient country provides adequate protection for personal data.

In the case of HIPAA, provisions of the Act provide rules directed towards administrative simplification and standardization of the electronic exchange of medical information between health care-related information systems. HIPAA seeks to establish standardized mechanisms for electronic data interchange (EDI), security, and privacy of health care-related data. HIPAA also mandates standardized formats for all patient health, administrative, and financial data, unique identifiers for each healthcare entity, including individuals, employers, health plans and health care providers, and security mechanisms to ensure confidentiality and data integrity for any information that identifies an individual. Any entity dealing with individually identifying health care information may be required to comply with the regulations of HIPAA.

One aspect of electronic exchange of medical information occurs between a health care provider and an insurance provider in handling the submission and payment of health care claims. In the course of billing between a health care provider and an insurer, the process is initiated when a health care provider submits a claim via HIPAA form 837 to an insurance provider for services provided by the health care provider to a patient. HIPAA form 837 includes personal health information fields, such as patient name and directly associated health care services received. HIPAA form 837 also includes commercial terms including health care provider identification, insurance provider identification, and services coded to a predefined HIPAA service category. Additionally, HIPAA form 837 indicates a face value. The face value is a price suggested by the health care provider as the value of the services provided, and may not indicate the amount that the health care provider expects the insurer to pay. In response to receiving HIPAA form 837, an insurer adjusts the amount of the claim to what the insurer may pay for such services or what the insurer may contractually be obligated to pay. The insurer may match the claimed services against the insurer's current reimbursement schedule for such services, which may have been previously negotiated between the health care provider and insurer. The insurer may further adjust the amounts to be paid for the claim to account for allowances that may be added or deducted in accordance with the insurer's business practices. When the insurer has adjusted one or more claims, the insurer creates a response in the form of a claim remittance advice via HIPAA form 835 indicating the amount the insurer will pay for each service by each patient.

In some cases, a health care provider seeks financing through the sale or hypothecation of medical receivables. As such, a health care provider may provide raw data of claims and remittance information to the financial services provider in support of the underlying asset(s) value as relates to such financing activity, such as a financial securitization transaction. The claims and remittance information may be provided in an unmatched state. That is, the payment information for a claimed service in HIPAA form 835 is not matched to the service and claim in a corresponding HIPAA form 837. For a financial institution to define an asset value for a claim or set of claims of medical receivables, the financial institution would need to estimate a value for each claim or set of claims. Because the claims and remittance advices may include personal health information subject to compliance under HIPAA, the financial services provider may also be subject to HIPAA regulations, and specifically, information security and compliance regulations as either a business partner or clearinghouse as defined under HIPAA regulations.

Under claim and remittance communications processes between health care providers and financial services providers, the determination of asset values is dependent on the ability of financial services providers to accurately value each claim. The value of a claim may depend on a variety of factors, such as the negotiated rates between a health care provider and insurer. For example, a value of a claim may be different in one region of the country from another region. In another case, the value for a certain type of claim may be different between different insurance providers and the same health care provider or between the same insurance provider and different health care providers. For example, an insurance company may pay more for a claim submitted by one health care provider than the same type of claim submitted from another health care provider. Additionally, each patient of a health care provider may have different insurances or no insurance. As such, a health care provider may get paid different amounts for the same type of service based on the patient. Thus, accurately valuing receivables data can be challenging in order to qualify the receivables as an asset with a specific value. In addition, as this raw data is provided by the health care provider to the financial service provider where the valuation function occurs, health care providers do not have control over the assets, such as the valuation and disposition of the asset, relative to the assets application against a variety of financial instruments.

### SUMMARY OF THE INVENTION

The present invention provides systems and methods for processing receivables data, such as medical receivables, to provide the receivables as an asset with a qualified financial value. For example, the medical receivables data may include an identifier of a health care related service for which a claim for payment is requested. The present invention describes systems and methods for assigning a predictive financial value for a service identified by the claim to create an asset with a qualified financial value and to create an agreement or financial instrument to pay the qualified financial value by a payer, such as a financial services provider.

In the case of medical receivables data, the present invention can generate and assign a predictive financial value to the health care related service based on a history of remittance advice or payments for services of the same type or category. In one aspect, the present invention processes claim submission data and remittance data to match payments for services with claims for payment for the service. In some embodiments, the matched payment to claim data provides a basis for the qualified financial value. In other embodiments, the matched payment to claim data is stored to provide a remittance history to determine a predictive value for the service.

In another aspect, the illustrative embodiment of the present invention processes receivables data into a financial instrument associated with a financial domain. For example, the present invention may generate a financial instrument for a financial services provider from the medical receivables data provided by the health care provider. A financial domain for the medical receivables data is identified and a financial domain key assigned to the data. The present invention applies financial domain business rules to the medical receivables data to generate a financial services data set, such as data representing or forming a financial instrument. Additionally, external data, such as credit information, may be used in conjunction with the receivables data to provide the financial services data. The present invention may include a financial services interface for use in communicating the financial services domain data, such as an electronic representation of a financial instrument or a component thereof, to a financial service provider.

In a further aspect, the illustrative embodiment of the present invention processes medical receivables data having individually identifiable health information such that a financial service provider handling the processed medical receivables data is not required to be compliant with laws and regulations dealing with the security and privacy of the individually identifiable health information. The present invention removes or encrypts the individually identifiable health information from the medical receivables data to provide data that does not identify an individual's health information. As such and in the case of HIPAA, the present invention can provide data concerning the qualified financial value of medical receivables to a receiving party, for example, a financial services provider, such that the receiving party is not required to become compliant with the HIPAA regulations as either a business partner or as a clearinghouse.

In one aspect, the present invention is related to a method for processing health care related claim data comprising individually identifiable health information to provide a financial related data set. The method includes the step of receiving a first data set representing a claim to payment for a health care related service. The first data set has individually identifiable health information and a portion of the first data set identifies a health care related service. In some embodiments, the first data set includes an American National Standards Institute Accredited Standards Committee X12 health care claim (837), and the individually identifiable health information includes information to be kept private in accordance with the Health Insurance Portability and Accountability Act (HIPAA). The method processes the first data set to form a second data set having at least the second portion of the first data set but free of individually identifiable health information. The present invention generates a predictive financial value for the health care related service identified by the first data set, and associates the predictive financial value with the health care related service in the second data set.

Additionally, the method of the present invention generates a key to identify the second data set. In some embodiments, the second data set is provided with the key to a financial services domain processing server or a financial services provider. The method of the present invention may also include determining one or more data elements of the first data set uniquely identifying the first data set. The one or more data elements may include one or more of the following: 1) a patient identifier, 2) an insurance company identifier, and 3) a category of service.

In one embodiment, the method of the present invention generates the predictive financial value from a history of remittance for a type or a category of the health care related service. In another embodiment, the predictive financial value is generated from a history of remittance between a submitter of the claim and a payer of the claim.

In some embodiments, the method of the present invention receives a third data set representing payment information regarding the health care related service. The third data set may include an American National Standards Institute Accredited Standards Committee X12 health care claim payment/advice (835). Additionally, the method may identify or match the third data set as providing payment information corresponding to the health care related service of the first data set.

In an additional aspect, the present invention is related to a device readable medium having device readable instructions to execute the steps of the method, as described above, related to processing health care related claim data comprising individually identifiable health information to provide a financial related data set.

In a further aspect, the present invention is related to transmitting via a transmission medium computer data signals representing device readable instructions to execute the steps of the method, as described above, related to processing health care related claim data comprising individually identifiable health information to provide a financial related data set.

In one aspect, the present invention is related to a system for processing medical receivables data. The system includes a receiver for receiving a first data set representing a claim to payment for a health care related service. The first data set has individually identifiable health information and a portion identifying a health care related service. In some embodiments, the first data set includes an American National Standards Institute Accredited Standards Committee X12 health care claim (837), and the individually identifiable health information includes information to be kept private in accordance with the Health Insurance Portability and Accountability Act (HIPAA).

The system also includes a predictive value generator and a processing mechanism. The predictive value generator generates a predictive financial value for the health care related service. The processing mechanism processes the first data set to form a second data set including at least the portion of the first data set and free of individually identifiable health information. The processing mechanism associates the predictive financial value with the health care related service in the second data set. In some embodiments, the system of the present invention includes a key generator for generating a key to identify the second data set. In further embodiments, the second data set with the key is communicated to a financial services domain processing system.

In one embodiment, the predictive value generator generates the predictive financial value from a history of remittance for a type or a category of the health care related service. In another embodiment, the predictive value generator generates the predictive financial value from a history of remittance between a submitter of the claim and a payer of the claim.

In some embodiments, the system of the present invention also includes a parser to determine one or more data elements of the first data set uniquely identifying the first data set. The one or more data elements may provide one of the following: 1) a patient identifier, 2) an insurance company identifier, and 3) a category of service.

In yet another embodiment of the present invention, the receiver receives a third data set representing payment information regarding the health care related service. The third data set includes an American National Standards Institute Accredited Standards Committee X12 health care claim payment/advice (835). The system may also include a matching engine to identify the third data set as providing payment information corresponding to the health care related service of the first data set.

In one aspect, the present invention is related to a method for processing data for health care related receivables. The method includes parsing a first data set representing a submission of a health care related claim for a first patient, and determining a first set of identifiers comprising one or more data elements uniquely identifying the first data set. The method also includes receiving a second data set representing payment information for one or more health care related claims for one or more patients, and parsing the second data set to determine a second set of identifiers comprising one or more data elements uniquely identifying the second data set. The method may store payment information of the second data set corresponding to the health care related claim in a storage location to provide a predictive financial value of remittance for a subsequently submitted health care related claim. The method may further include the step of comparing the second set of identifiers to the first set of identifiers to determine if the second data set comprises payment information of a health care related claim of the first patient.

In one embodiment, the first data set comprises an American National Standards Institute Accredited Standards Committee X12 health care claim (837), and in another embodiment, the second data set comprises an American National Standards Institute Accredited Standards Committee X12 health care claim payment/advice (835). In some embodiments, the first data set or the second data set has individually identifiable health information. The individually identifiable health information may include information to be kept private in accordance with the Health Insurance Portability and Accountability Act (HIPAA).

In some embodiments, the method of the present invention also parses the second data set to determine identifiers on a patient by patient basis. In one embodiment, the method further determines if the second set of identifiers correspond to the first set of identifiers, and providing a third data set. The third data set includes the first data set and a portion of the second data set related to the first patient. The method may assign a first key to the third data set, and also may store the third data set to a storage location accessible via the first key.

In other embodiments, the method of the present invention includes generating a fourth data set from the first data set or the second data set, and generating the fourth data set so as not to have individually identifiable health information as in the first or second data set. The present invention may also assign a second key to the fourth data set. The second key may be associated with a first key. The first key identifies a third data set having the first data set and a portion of the second data set related to the first patient. The fourth data set and the second key may be provided to a financial services provider or a financial services processing interface.

In one aspect, the present invention is related to a device readable medium having device readable instructions to execute the steps of the method, as described above, related to processing data for health care related receivables.

In a further aspect, the present invention is related to transmitting via a transmission medium computer data signals representing device readable instructions to execute the steps of the method, as described above, related to processing data for health care related receivables.

In yet a further aspect, the present invention is related to a method for processing health care related receivables data into a form for use in a financial domain. The method provides a first data set of health care related receivables data. The first data set having a first key and identifying a service and a financial value for the service. The method further includes the steps of identifying a financial domain for the first data set, assigning a first domain key to the first data set, processing the first data set using a business rule for the identified financial domain, and generating a second data set from the processed first data set to provide desired financial information for the identified financial domain.

In some embodiments, the first data set may have been derived from health care related data having individually identifiable health information. However, the first data set is provided in a form free of individually identifiable health information. In one embodiment, the present invention associates the first domain key with the first key. In other embodiments, the present invention may also associate a second domain key as a sub-key of the first domain key.

In further embodiments, the present invention may associate a third data set with the first data set to generate the second data set. The third data set may include credit related information of a service provider related to the service identified by the first data set.

In some embodiments, the present invention provides the second data set as a financial instrument to a financial services provider. The financial value for the service may include a predictive value of remittance based on one or more of the following: 1) type of service, 2) history of remittance for the type of service, or 3) history of remittance between a service provider and payer.

In one aspect, the present invention is related to a device readable medium having device readable instructions to execute the steps of the method, as described above, related to processing health care related receivables data into a form for use in a financial domain.

In a further aspect, the present invention is related to transmitting via a transmission medium computer data signals representing device readable instructions to execute the steps of the method, as described above, related to processing health care related receivables data into a form for use in a financial domain.

In one aspect, the present invention is related to a system for processing health care related receivables data into a form for use in a financial domain. The system includes a receiver, a domain key generator and a domain processing engine. The receiver receives a first data set of health care related receivables data. The first data set having a first key and identifying a service and a financial value for the service. The domain key generator identifies a financial domain for the first data set, and assigns a first domain key to the first data set. The domain processing engine processes the first data set using a business rule for the identified financial domain, and generates a second data set from the processed first data set to provide desired financial information for the identified financial domain.

In one embodiment, the domain key generator of the present invention associates the first domain key with the first key. In another embodiment, the domain key generator associates with the first data set a second domain key as a sub-key of the first domain key.

In some embodiments of the present invention, the domain processing engine uses a third data set with the first data set to generate the second data set. The third data set may include credit related information of a service provider related to the service identified by the first data set.

The system of the present invention may also include a financial services interface to communicate the second data set as an element or component of a financial instrument to a financial services provider. In some embodiments of the system, the financial value for the service includes a predictive value of remittance based on one or more of the following: 1) type of service, 2) history of remittance for the type of service, and 3) history of remittance between a service provider and payer.

In yet a further aspect, the present invention is relates to a method for processing receivables data into a financial instrument. The method includes the steps of providing receivables data having one or more items to be assigned a value, generating a financial value to assign to the one or more items, and generating financial services data having the one or more items and the financial value assigned to the one or more items. The method further includes identifying a financial domain for the financial services data, processing the financial services data using a business rule for the identified financial domain, and providing the financial instrument from the processed financial services data. The business rule identifies a financial instrument to be generated from the financial services data.

In one embodiment, the receivables data represents medical receivables. In some embodiments, the one or more items represent a service or a product. In an additional embodiment, the assigned financial value provides a qualified value of an asset identified by the one or more items. Additionally, the financial instrument generated by the present invention may include a securitization of an asset represented by the receivables data. In some embodiments, the present invention may communicate the financial instrument to a financial services provider.

In one aspect, the present invention is related to a device readable medium having device readable instructions to execute the steps of the method, as described above, related to processing receivables data into a financial instrument.

In a further aspect, the present invention is related to transmitting via a transmission medium computer data signals representing device readable instructions to execute the steps of the method, as described above, related to processing receivables data into a financial instrument The details of various embodiments of the invention are set forth in the accompanying drawings and the description below.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 is a block diagram of a computing device used in practicing the illustrative embodiment of the present invention

FIG. 2A is a block diagram of an environment for practicing an illustrative embodiment of the present invention;

FIG. 2B is a block diagram of an environment for practicing an illustrative embodiment of the present invention;

FIG. 3A is a block diagram of an illustrative medical receivables processing system for practicing an embodiment of the present invention;

FIG. 3B is a block diagram of illustrative operations of the medical receivables processing system of FIG. 3A for practicing an embodiment of the present invention;

FIG. 3C is a flow diagram depicting steps performed in an illustrative method of processing medical receivables of the present invention in the illustrative system of FIGS. 3A and 3B;

FIG. 3D is a flow diagram depicting steps performed in another illustrative method of processing medical receivables of the present invention in the illustrative system of FIGS. 3A and 3B;

FIG. 4A is a block diagram of an illustrative financial services domain processing system for practicing an embodiment of the present invention;

FIG. 4B is a block diagram of illustrative operations of the financial services domain processing system of FIG. 4A for practicing an embodiment of the present invention; and

FIG. 4C is a flow diagram depicting steps performed in an illustrative method of processing financial services data of the present invention in the illustrative system of FIGS. 4A and 4B.

### DETAILED DESCRIPTION

Certain embodiments of the present invention are described below. It is, however, expressly noted that the present invention is not limited to these embodiments, but rather the intention is that additions and modifications to what is expressly described herein also are included within the scope of the invention. Moreover, it is to be understood that the features of the various embodiments described herein are not mutually exclusive and can exist in various combinations and permutations, even if such combinations or permutations are not expressly made herein, without departing from the spirit and scope of the invention.

The illustrative embodiment of the present invention provides systems and methods for processing receivables related data, such as medical receivables, to create an asset with a qualified financial value. The medical receivables data identifies a health care related service for which a claim for payment is requested. The present invention processes the medical receivables data to assign a qualified financial value to the claim for payment of the health care related service. In one aspect, the present invention processes claim submission data and payment data to match payments for services with claims for payment for the service. Additionally, the illustrative embodiment of the present invention also processes receivables data into a financial instrument associated with a financial domain. Financial domain business rules are applied to the receivables data to generate a financial services data set, such as data representing an element or component of, or otherwise forming a financial instrument. Additionally, external data, such as credit information, service level agreements, service provider agreements, and related securitization conduit formation processes, may be used in conjunction with the receivables data to provide the financial instrument to a financial services provider.

In a further aspect, the illustrative embodiment of the present invention processes medical receivables data having individually identifiable health information such that a financial service provider handling the processed medical receivables data is not required to be compliant with laws and regulations dealing with the security and privacy of the individually identifiable health information. The present invention removes or encrypts the individually identifiable health information from the medical receivables data to provide data that does not identify an individual's health information. As such and in the case of HIPAA, the present invention can provide data concerning the qualified financial value of medical receivables to a receiving party, for example, a financial services provider, such that the receiving party is not required to become compliant with the HIPAA regulations as either a business partner or as a clearinghouse.

Although the illustrative embodiment is generally discussed below in conjunction with American National Standards Institute Accredited Standards Committee X12 transactions for claim submissions (HIPAA Form 837) and remittance and payment information (HIPAA Form 835) in view of HIPAA and medical receivables, one ordinarily skilled in the art will recognize and appreciate that the present invention may be used for and practiced with any type and/or form of receivables related data, medical, non-medical or otherwise. For example, the present invention may be practiced with invoice and payment data for any type of service or product, either exchanged via an Electronic Data Interchange (EDI) mechanism or otherwise. Additionally, personal or private information identifiable in the receivables data may be desired to be kept confidential or private in view of or compliance with other privacy laws and regulations, such as the European Union's Data Directive, or for any other reason or purpose.

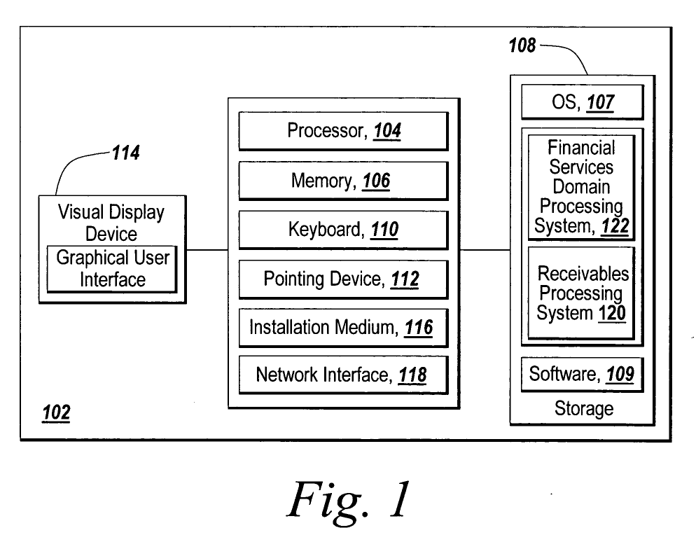

Referring to FIG. 1, an illustrative embodiment of a computing device 102 used in practicing an embodiment of the present invention is depicted. The computing device 102 has memory 106, on which software according to one embodiment of the present invention may be stored, a processor (CPU) 104 for executing software stored in the memory 106, and other programs for controlling system hardware. The memory 106 may comprise a computer system memory or random access memory such as DRAM, SRAM, EDO RAM, etc. The memory 106 may comprise other types of memory as well, or combinations thereof. A human user may interact with the computing device 102 through a visual display device 114 such as a computer monitor, which may be used to display a graphical user interface (GUI).

The computing device 102 may include other I/O devices such a keyboard 110 and a pointing device 112, for example a mouse, for receiving input from a user. Optionally, the keyboard 110 and the pointing device 112 may be connected to the visual display device 114. Additionally, the computing device 102 may include any type of input device for receiving user input, such as a joystick. In other embodiments, the computing device 102 may include any type of haptic or tactile feedback device, such as a vibration generating mouse, or a force feedback device such as a force feedback joystick. Also, the computing device 102 may include any type of sound producing I/O device such as any suitable sound card. The computing device 102 may include other suitable conventional I/O peripherals.

For installing software programs, the computing device 102 may support any suitable device readable medium 116, such as a CD-ROM, DVD-ROM floppy disks, tape device, USB device, hard-drive, or any other suitable device. The computing device 102 may further comprise a storage device 108, such as a hard-drive or CD-ROM, for storing an operating system 107 and other related software 109. Any portion of the receivables processing system 120 and/or the financial services domain processing system 122 of the present invention illustrated in FIG. 1 may comprise software that is installed via a device readable medium 116 or stored in the storage device 108. Furthermore, any portion of the receivables processing system 120 and/or the financial services domain processing system 122 of the present invention may be executed on the processor 104 or stored in memory 106.

Additionally, the computing device 102 may include a network interface 118 to interface to a network, including a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), cluster interconnection (Myrinet), peripheral component interconnections (PCI, PCI-X), wireless connections, or some combination of any or all of the above. The network interface 118 may comprise a built-in network adapter, network interface card, PCMCIA network card, card bus network adapter, wireless network adapter, USB network adapter, modem or any other device suitable for interfacing the computing device 118 to any type of network capable of communication and performing the operations described herein.

Moreover, the computing device 102 may be any type and/or form of computer system such as a workstation, desktop computer, server, laptop, handheld computer or other form of computing or telecommunications device that is capable of communication and that has sufficient processor power and memory capacity to perform the operations described herein.

In one aspect, the receivables processing system 120 and/or the financial domain services processing system 122 of the present invention is related to the electronic communication of receivables related information between a health care provider and payer, such as an insurance provider, and any clearinghouses or intermediaries that may be used to facilitate the communication. For example, in view of HIPAA related transactions, the health care provider may communicate a health care claim to the payer or insurance provider in the form of an American National Standards Institute Accredited Standards Committee X12 health care claim referred to as HIPAA Form 837. In response to the claim submission, the insurance provider may communicate payment or remittance advice regarding the health care claim in form of an American National Standards Institute Accredited Standards Committee X12 health care claim payment/advice referred to as HIPAA Form 835. In some case, the HIPAA Form 835 and 837 transactions may be facilitated via a third party, such as an intermediary or clearinghouse that provides HIPAA related support and assistance.

As used herein, a claim or data representing a claim, i.e., claim data, includes information related to the submission of a claim, such as a claim for a health care related service under an insurance contract. In one aspect, a claim is a demand or request for payment, reimbursement, or indemnification for a loss or benefit from another party. For example, the claim may represent a demand or request for payment for a service or product, such as a service or product obtained at a health care provider. In another aspect, a claim is a demand or request for payment in accordance with an insurance policy or other formal arrangement. For example, a claim is a request by a health care provider to an insurer to receive payment for a service provided to an individual insured by the insurer.

As used herein, the term “securitization” or “asset securitization” refers to the process of homogenizing and packaging financial instruments into a new fungible one. Acquisition, classification, collateralization, composition, pooling, and distribution are functions within this process. For example, securitization or asset securitization refers to a device of structured financing where an entity seeks to pool together its interest in identifiable cash flows over time, transfer the same to investors either with or without the support of further collaterals, and thereby achieve the purpose of financing. Though the end-result of securitization is financing, it is not “financing” as such, since the entity securitizing its assets it not borrowing money, but selling a stream of cash flows that was otherwise to accrue to it.

As used herein the term “securitization conduit” refers to a medium or a legal vehicle specific to securitizations. In other word, an entity is formed to hold receivables transferred by the originator on behalf of the investors.

As used herein the term “special purpose vehicle” refers to an organization constructed with a limited purpose or life. Frequently, special purpose vehicles serve as a securitization conduit. In relation to securitization a special purpose vehicle refers to the entity which would hold the legal rights over the assets transferred by the originator.

In some embodiments, the claim may include an electronic form representing the submission of the demand or request for payment. In an exemplary embodiment, the claim data may comprise an electronic form of the EDI transaction for an American National Standards Institute Accredited Standards Committee X12 health care claim HIPAA Form 837 transaction. In one embodiment, the claim data includes any of the elements, data, fields, or values as specified by the National Electronic Data Interchange Transaction Set Implementation Guide, Health Care Claim: Professional 837, ASC X12N 837 (0004010X098) published May 2000 by the Washington Publishing Company and incorporated herein by reference. The claim data may include any suitable structure, syntax, and semantics to represent, define, or identify one or more of the following: 1) billing provider name, contact information, and billing information; 2) pay-to provider name and contact information; 3) subscriber name and contact information; 4) payer name and contract information; 5) responsible party name and contact information; 6) credit/debt card holder name and card information; 7) patient name and contact information; 8) claim information; 9) home health care plan information; 10) referring, rendering, and or purchased service provider name; 11) service facility location; and 12) health care related service information. The claim information may include one or more dates regarding orders, treatment, x-rays, referral, date last seen, onset of illness, accident, date of birth, disability, admission, discharge, absence, or return to work, and any other date related to providing health care to an individual. The claim information may also include information about the patient amount paid and total purchased service amount. The service information may include any dates or range of dates regarding the order, referral, or performance of the service, and any information identifying the type of service purchased, including text description, acronyms, codes, or other suitable identifiers for the service.

Also as used herein, payment or data representing a payment, i.e., payment data, includes information related to the remittance of or payment for a service or product, such as a payment for a health care related service or product submitted via a claim. In one aspect, payment or remittance includes information regarding money or funds sent, or to be sent, from one to another in payment for items purchased, services rendered, or value received. In another aspect, remittance is a statement communicated to a health care provider from an insurance company to indicate that payment was issued and the amount of the payment.

In some embodiments, payment data includes an electronic form of the payment information. In an exemplary embodiment, the payment data may include an electronic form of the EDI transaction for an American National Standards Institute Accredited Standards Committee X12 health care claim HIPAA Form 835 transaction. In one embodiment, the payment data includes any of the elements, data, fields, or values as specified by the National Electronic Data Interchange Transaction Set Implementation Guide, Health Care Claim/Payment Advice 835, ASC X12N 835 (0004010X0981) published May 2000 by the Washington Publishing Company and incorporated herein by reference. The payment data may include any suitable structure, syntax, and semantics to represent, define, or identify one or more of the following: 1) identification and contact information for one or more payers; 2) identification and contact information for one or more payees; 3) claim payment information, and 4) service payment information. The claim payment information may include information regarding patient name, insured name, service provider name, rendering provider identification, claim date, claim contact information, and inpatient/outpatient adjudication information. The service payment information may include a service date, service identification or service code, service adjustment, and rendering provider information.

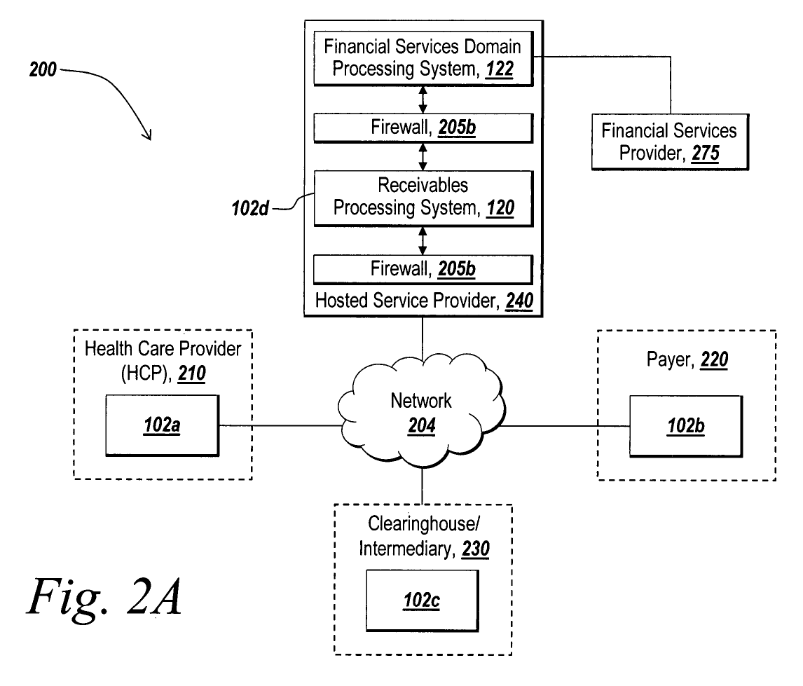

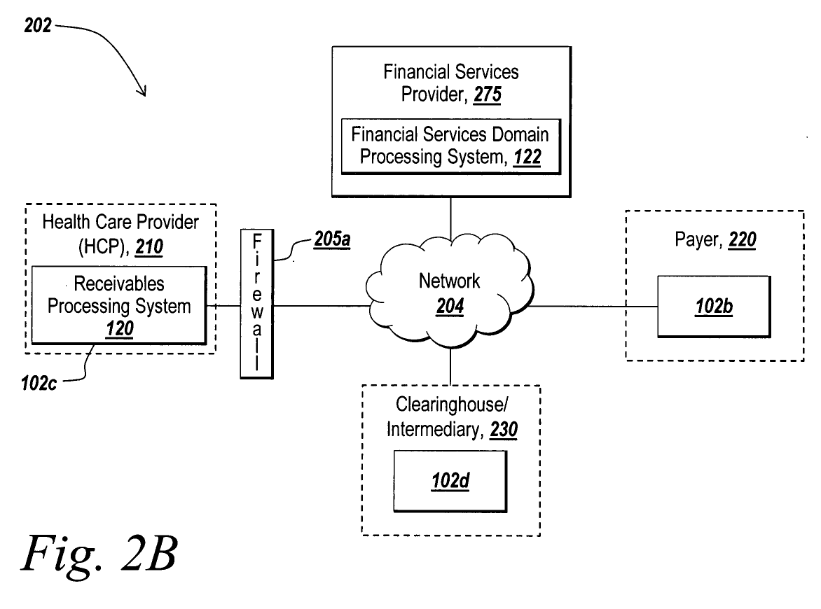

Referring now to FIG. 2A, an illustrative environment 200 for practicing the present invention is depicted. In brief overview, a health care provider 210, a payer 220, and/or a clearinghouse or intermediary 230 may have one or more computing devices 102a-102c in communication over a network 204 with a computing device 102d of a hosted service provider 240. The hosted service provider 240 may provide the functionality, structure, and operations of the receivables processing system 120 and/or the financial services domain processing system 122 of the present invention, and may be accessible in a secure manner via any suitable type and/or form of firewall 205a-205b. Additionally, the hosted service provider 240 may be in communication with one or more financial services providers 275 via any suitable type and/or form of interface. The network 204 may be any type and/or form of network, such as a public or private network, and in one embodiment, may be used to communicate any electronic data interchange (EDI) communications, such as any type of HIPAA transaction.

The health care provider 210 may be any type and/or form of provider related to health care services. In one embodiment, a health care provider 210 is any person or entity that furnishes, bills or is paid for health care in the course of business. A health care provider 210 may include persons, such as doctors and dentists, entities, such as hospitals and clinic, or alternative care providers, such as homeopaths and acupuncturists. Also, a health care provider 210 may include a provider of care and services as well as a provider of health supplies, such as pharmacists. In another embodiment, a health care provider 210 may be the entity or individual that submits a health care related claim for remittance. In other embodiments, a health care provider 210 may be the entity or individual that provides a service related to the health care claim. One ordinarily skilled in the art will recognize and appreciate the various types of health care providers that may be used in practicing the operations of the present invention.

The payer 220 may be any type and/or form of entity or individual responsible or designated to pay or make payment for a health care related claim. In some embodiments, the payer 220 is an insurance provider. For example, the insurance provider 220 is the party to an insurance arrangement, who undertakes payment for losses, provides benefits or renders services. In another embodiment, the payer 220 may be any entity or institution, such as a corporation, engaged primarily in the business of furnishing insurance to another, such as an individual or a member of the public. In one embodiment, the payer 220 is the party, such as a company, that issues a policy to a policyholder related to health care. In some embodiments, the payer 220 may be a company or entity that is self-insured and providing health care related insurance to its employees or other individuals related to the entity. In some embodiments, the payer 220 is the designated entity for which payment for a health care related service is requested. One ordinarily skilled in the art will recognize and appreciate the various types of payers and insurance providers that may be used in practicing the operations of the present invention.

The clearinghouse or intermediary 230 may be any type and/or form of entity or service used to facilitate communications, transactions, or processing of other information and data related to either the health care provider 210 and/or the payer 220. As such, the clearinghouse intermediary 230 may be a central or intermediate point for collecting, classifying, and distributing information or assistance, such as information or assistance related to health care. In one embodiment, the intermediary 230 processes information received in a nonstandard format or containing nonstandard data content into a standard transaction, or receives a standard transaction and processes that information into a nonstandard transaction. In some embodiments, the intermediary 230 is used to reformat claim information to conform to the HIPAA standard and electronically submit the claim to the payer 220. In one embodiment, the intermediary 230 may be a HIPAA related clearinghouse, which acts as a translator and/or facilitator to connect payers 220 and providers 210. In other embodiments, an intermediary 230 may act as a financial clearinghouse to settle claims and payments for claims between the health care provider 210 and the payer 220. The intermediary may be an organization, entity or service related to a HIPAA exchange of information that completes transactions on that exchange and provides validation, delivery, and/or settlement with regards to the transaction. For example, the intermediary may be a financial organization that matches claims and remittance for claims that take place between a health care provider 210 and payer 220 and keeps track of the obligations and payments required of the provider 210 and payer 220. One ordinarily skilled in the art will recognize and appreciate the various types of clearinghouses and intermediaries that may be used in practicing the operations of the present invention.

The hosted service provider 240 may be any type of organization, entity, or service that provides medical receivables processing and/or financial services domain processing in accordance with the operations of the present invention described herein. The hosted service provider 240 may comprise a hosted website, ecommerce or internet service providing the functionality of the receivables processing system 120 and/or the financial services domain processing system 122 of the present invention. In one aspect, the host service provider 240 may be or act as a type or form of clearinghouse or intermediary 230 to the health care provider 210 and/or payer 220. In some embodiments, the hosted service provider 240 provides a secure mechanism for the flow, processing, or storage of health care information between health care providers 210, payers 220, intermediaries 230 or financial services provider 275.

The financial services provider 275 may be any type and/or form of provider related to finances, investment, and/or money. As those skilled in the art will recognize, financial services is a term used to refer to the services provided by the finance industry, which may include banks, insurance companies, investment banks, brokerages, and other service providers. In some embodiments, the financial services provider 275 may provide or perform services related to the commercial paper market. In one embodiment, the financial services provider 275 provides or performs services related to medical receivables financing. The financial services provider 275 may provide or have any type of suitable interface to communicate information with the financial services domain processing system 122 of the present invention.

As will be discussed in further detail below, the receivables processing system 120 of the present invention may be used to process medical receivables related data to provide financial related data to create an asset with a qualified financial value. Additionally, the receivables processing system 120 of the present invention may be used to process medical receivables related data to provide financial data compliant with various rules, regulations, and laws requiring personal information to remain private. In one embodiment, the receivables processing system 120 may receive a HIPAA Form 837 for a health care claim from the health care provider 210 or intermediary 230. In another embodiment, the receivables processing system 120 may receive a HIPAA Form 835 for remittance for a health care claim from the payer 220 or an intermediary 230. The receivables processing system 120 may process the HIPAA Form 837 and/or HIPAA Form 835 to provide a financial services related data set to the financial services domain processing system 122. In the case of HIPAA, the financial services related data set does not include any individually identifiable health information which would require security and privacy compliance under HIPAA. The financial services domain processing system 122 processes the financial services related data to apply domain specific business rules to the data to provide domain specific financial data, such as an electronic financial instrument to a financial services provider 275. As one ordinarily skilled in the art will recognize and appreciate, the receivables processing system 120 and the financial services domain processing system 122 may comprise software, hardware, or any combination of software and hardware.

In other embodiments, the receivables processing system 120 and financial services domain processing system 122 of the present invention may be deployed in various architectures and configurations. For example, as illustrated in the environment 202 of FIG. 2B, the receivables processing system 120 may be hosted on one or more computing devices 102c of the health care provider 210 and may communicate via a firewall 205a over the network 204 to the payer 220, clearinghouse/intermediary 230, and/or the financial services provider 275. The financial services provider 275 may provide or host the financial services domain processing system 122, which, in one embodiment, may interface with or communicate directly with the receivables processing system 120 of the health care provider 120.

As one ordinarily skilled in the art will recognize and appreciate, the receivables processing system 120 and/or financial services domain processing system 122 of the present invention may be deployed at any entity, organization, or service provider related to or participating in the communication of medical receivables related data. Additionally, the receivables processing system 120 or financial services domain processing system 122 may be distributed across one or more of the participating entities, organizations or service providers. For example, a first portion of the receivables processing system 120 may be executed at the hosted service provider 240 and a second portion of the receivables processing system 120 at the health care provider 210.

Also, the receivables processing system 120 and/or financial services domain processing system 122 may receive communications as described herein at any point in the network 204. For example, the receivables processing system 120 may tap into any network communication interface, connection, wire, or channel associated with the health care provider 210 to obtain or receive medical receivables related data. In one embodiment, the medical receivable processing system 120 includes or uses a network device to intercept, mirror, or otherwise obtain a copy of desired network traffic. In another embodiment, the health care provider 230 sends a copy of the communication sent to a payer 230 or intermediary 230 to the hosted service provider 240 or otherwise to the receivables processing system 120.

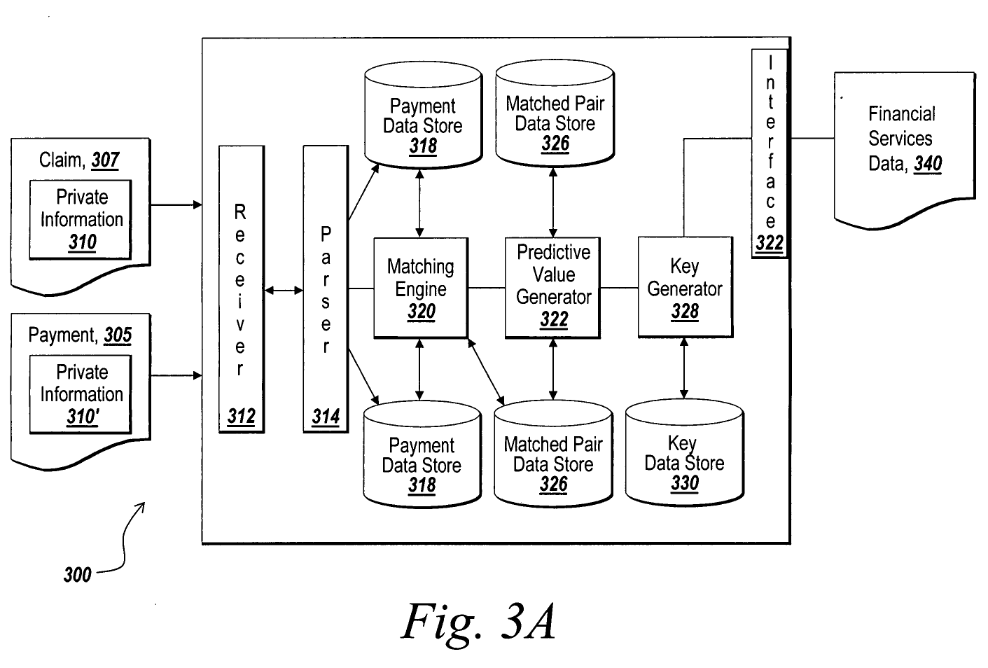

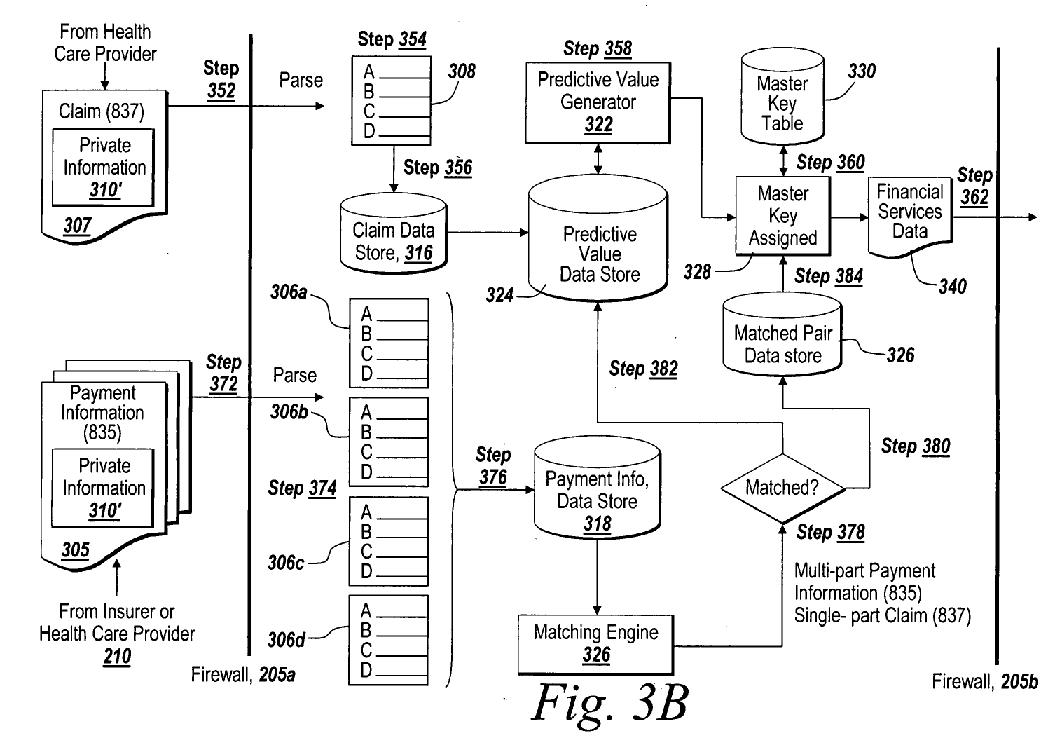

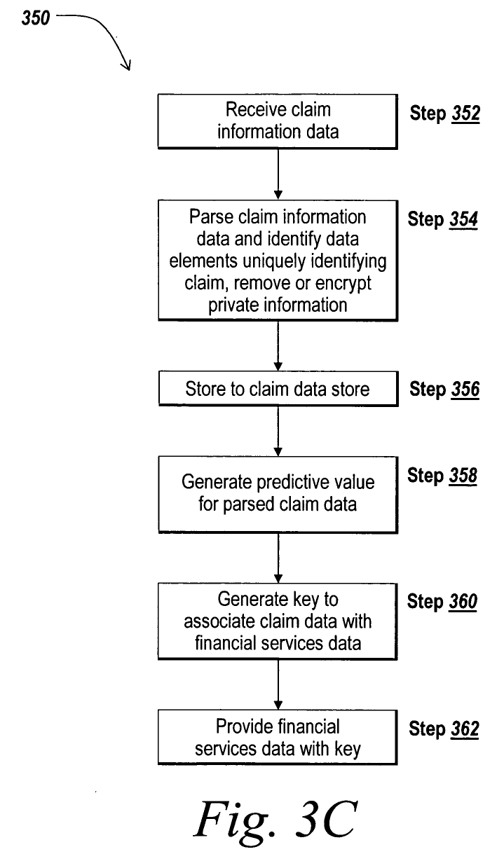

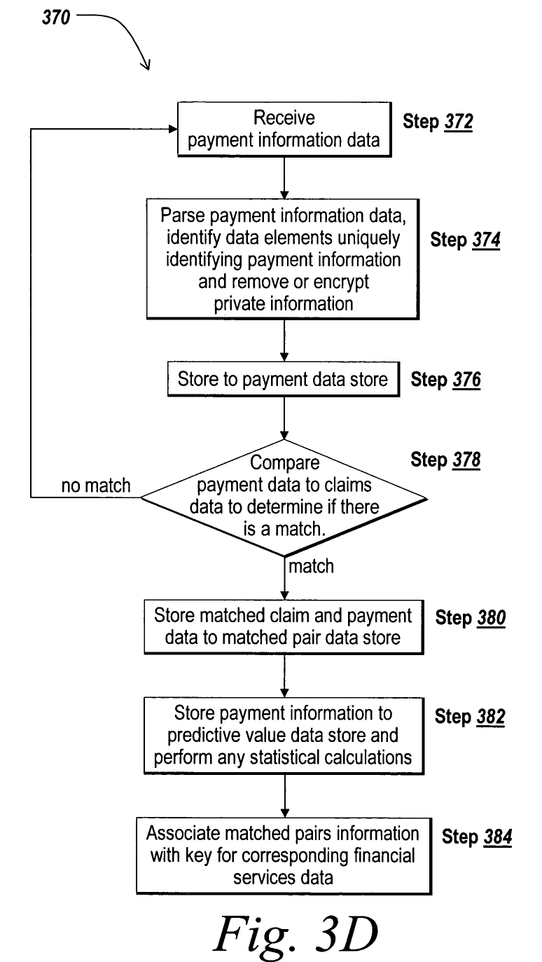

The structure, functions, and operations of the receivables processing system 120 of the present invention will be discussed in conjunction with FIGS. 3A-3D. FIG. 3A depicts an illustrative embodiment of the receivables processing system 120 while FIGS. 3B, 3C and 3D depict methods for practicing an illustrative embodiment of the present invention. Referring now to FIG. 3A, the illustrative environment 300 depicts a receivables processing system 120, which receives as input claim related data 307 and payment related data 305, and provides financial services related data 340 as output.

In brief overview, the receivables processing system 120 includes a receiver 312 in communication with a parser 314. The receiver 312 receives the claim data 307, such as HIPAA form 837 data, and payment data 305, such as HIPAA form 835 data, by any suitable interface and communication mechanism. The claim data 307 may identify one or more health care related services for which remittance is requested, and the payment data 305 may identify remittance or advice about remittance with regards to one or more health care related services for which remittance is requested. The claim data 307 and/or the payment data 305 may include private information 310, 310′ such as individually identifiable health information. The parser 314 parses the received data 305, 307 to identify and process the desired elements represented by the data, and also to remove any private information 310, 310′. The parser 314 may parse out elements that uniquely identify the data set, such as one or more fields or values in the data 305, 307. The claim data 307 may be stored to a claim data store 316, such as a database, and the payment data 305 may be stored to a payment data store 318, such as the same database as the claim data 307 or another database.

In further overview, the receivables processing system 120 also includes a matching engine 320, a predictive value generator 322, and a key generator 328. The matching engine 320 matches payment data 305 with corresponding claim data 307. For example, the matching engine 320 matches payment information in the payment data 305 with a corresponding claim information in the claim data 307, or HIPAA 835 payment data 305 with the corresponding HIPAA 837 claim data 307. The matching engine 320 may be in communication with the parser 314, the claim data store 316, and/or the payment data store 318 to obtain or receive claim and payment data for matching. Upon determining a match, the matching engine 320 may store matched claim and payment data to a matched pair data store 326, such as a database. The predictive value generator 322 determines and assigns a financial value for one or more health care related services identified via the claim data 307. The predictive value generator 322 may be in communication with a predictive value 324 data store and/or the matched pair data store 326 to obtain financial values related to the service. The key generator 328 of the present invention generates and assigns a unique key to data processed by the receivables processing system 120 to be used to provide the financial services data 340 via any type and/or form of a suitable interface mechanism 322. The key assigned to the financial services data 340 may be associated with the claim data 307 and payment data 305 and stored in a key data store 330.

The claim data 307 and payment data 305 may include any type and/or form of electronic representation and medium as those ordinarily skilled in the art will appreciate. In one embodiment, the data may include a file such as an XML file or a file in any other markup language. In some embodiments, the data 305, 307 may be text or ASCII based data, while in other embodiments, the data 305, 307 may be binary data. In another embodiment, the data 305, 307 may include a medium of one or more network transmissions, such as via one or more network packets. For example, the data 305, 307 may be the payload of a TCP/IP packet in an Internet Protocol (IP) based network 204. In further embodiments, the data 305, 307 may include or be represented by an object, such as an object passed via a function call, such as a web service call or transaction. The object may further be serialized or marshaled to communicate the data 305, 307 via the network 204. In yet another embodiment, the claim data 307 may include a scanned in or electronic copy of a paper invoice or other paper representing the claim. Likewise, the payment data 307 may include a scanned in or electronic copy of a paper representing remittance or advice regarding payment. One ordinarily skilled in the art will recognize and appreciate the various type and forms of claim and payment data that may be used in practicing the illustrative embodiment of the present invention.

The private information 310, 310′ portion of the claim data 307 and/or payment data 305 may include data that may be considered confidential, secret, classified, privileged, private, or otherwise sensitive. In one embodiment, the private information 310, 310′ identifies health related information of an individual, such as any data considered individually identifiable health information under HIPAA laws and regulations. In some embodiments, the private information 310, 310′ may comprise one or more values, elements, or fields that in combination may be considered confidential, secret, classified, privileged, private, sensitive, or in other embodiments, may comprise individually identifiable health information.

The receiver 312 and parser 314 of the present invention may include any suitable means and mechanisms for receiving the claim data 307 and payment data 305, and parsing the claim data 307 and payment data 305 to identify, extract, process, and/or remove desired portions of the data 305, 307. In some embodiments, the receiver 312 is a socket-based mechanism to receive network packets comprising the data 305, 307 via a network 204. In other embodiments, the receiver 312 is an application, program, process, service, or task constructed to receive or obtain the data 305, 307 in electronic form. In one embodiment, the receiver 312 may receive the data 305, 307 via a fax or phone line transmission, while in other embodiments, the data 305, 307 may be received wirelessly. In other embodiments, the receiver 212 may comprise an Internet based interface, such as a web service or XML interface.

The parser 314 analyzes the structure and content of the data 305, 307 to identify, organize, or separate units of information in the data 305, 307. In some embodiments, the parser 314 comprises an application, program, library or script, such as a Perl, Awk, or Java script. In other embodiments, the parser 314 is designed or configured to identify portions of the data 305, 207 that uniquely identifies the instance or set of data 305, 307. In some embodiments, the parser 314 parses out and removes the private information 310, 310′, or extracts the private information 310, 310′ to be stored in a secure manner separate from other portions of the data 305, 307. In a further embodiment, the private information 310, 310′ is identified and encrypted and, in additional embodiments, processed and stored with the other portions of the data 305, 307. In one embodiment, the parser 314 interfaces to the data stores 316, 318 by any suitable database access technology to store the parsed data in an organized fashion with identified fields or data elements and corresponding values, such as via a relational database.

The matching engine 326 comprises an application, program, library, script, service, process, or task for matching information of a payment 305 corresponding to information of a claim 307, such as payment advice of HIPAA Form 835 matching the corresponding claim of HIPAA Form 837 as those skilled in the art would appreciate. The matching engine 326 may include any logic, algorithms, or business rules for matching portions of the claim 307 to portions of a payment 305 to determine if the payment 305 corresponds to the claim 307. In one embodiment, the matching engine 326 performs queries on the claim and/or payment data stores 316, 318 to determine if there exists a claim 307 that corresponds to a payment 305. In some embodiments, the matching engine 326 has the claim 307 and payment 305 data in memory in any suitable data structure or object and uses the data structure or object to compare and determine if a payment 305 corresponds to a claim 307. In one embodiment, the matching engine 326 uses uniquely identified elements of the data 305, 307 determined by the parser 314 or configured into the matching engine 326 to determine any matches between claims and payments. For example, the matching engine 326 may use the patient name, claim information, service information, service provider information fields of the payment and claim data 305, 307 to determine if there is a match. In one embodiment, the matching engine 326 stores matched claim and payment data 305, 307 to the matched pair data store 326. The matching engine 326 may use any suitable database access technology to store the matched data in an organized fashion in a relational database. For example, the matching engine 326 may store and organize the matched pairs according to HIPAA product and service codes identified in HIPAA Forms 835 and 837.

The predictive value generator 322 comprises an application, program, library, script, service, process, or task for generating and assigning a financial value to a service of a claim 307, either matched to a payment 307 or net yet matched. The predictive value generator 322 comprises any logic, algorithms, or business rules for determining a dollar value in any type of currency to assign a service represented by the claim 307. In one embodiment, the predictive value generator 322 uses a lookup table, such as a lookup table in the predictive value data store 324. The lookup table may be populated with predetermined financial values for a service by name, type, date, category, or provider of the service. In one embodiment, the lookup table of the predictive value data store 324 is populated or updated using any payment information matched to a claim as stored in the matched pair data store 326. In another embodiment, the predictive value generator 322 queries the matched pair data store 326 to determine, find or obtain a value for a service from the payment history for the same or similar service related to the claim 307. The query may be based on a date range, service type, or category, and by provider and/or payer. In one embodiment, if the payment and claim are matched, the predictive value generator 322 uses the actual payment for the service/claim as the financial value for the service/claim.

In one embodiment, the predictive value generator 322 uses one or more predictive value algorithms. For example, in one embodiment, an average payment value for a service can be calculated by taking the sum of the same claim/payment matches divided by the number of such matches. This average can be calculated by any combination of provider, payer, and HIPAA code or service type or category. Additionally, the average can be calculated according to any date range and/or the last n occurrences or instances of the service. Then, as one ordinarily skilled in the art will recognize and appreciate, any type and/or form of statistical formula may be applied to generate a standard deviation, and to assign a number representing the statistical relevance of the predictive value.

As output, the predictive value generator 322 may provide a predictive financial value for the service of the claim, a variance range, and/or a statistical deviation. The predictive financial value may be associated with a claim 307, an identifier of the claim 307, or a service identified in the claim 307. A receivable assigned a predictive value, such as a medical receivable represented by claim 307 provides or identifies an asset with a closely approximated financial value. In one aspect, the financial value is considered a qualified financial value based on the payment history for the service between a health care provider 210, and a payee 220, such as an insurer. The financial value is further qualified based on the statistical relevance provided by the variance range and statistical deviation output. In another aspect, the financial value is qualified because the receivables processing system 120 tracks and maintains in a secure manner the underlying medical receivables data supporting the financial services data 340. As such, the predictive value generator 322 processes the medical receivables data 305, 307 to provide a financial services data set 340 that can be used by a financial service provider 275.

In some embodiments, the key generator 322 comprises an application, program, library, script, service, process, or task for generating a key, such as a master key, to assign a set of data. In other embodiments, the key generator 322 comprises hardware, or a combination of software and hardware. The key may comprise any combination of letter, numeric, and alpha-numeric characters or symbols to uniquely identify a data set processed by the present invention. In one embodiment, the key comprises a database key for storing the data set, such as the financial services data 340, in a database. In another embodiment, the key comprises an encryption key for securely transmitting the processed data set. In a further embodiment, the key is a software key assigned to the processed data set. In some embodiments, the key is incorporated in the financial services data 340 while in other embodiments, the key is provided separately but in association with the financial services data 340.

The key generator 328 stores the generated key in a key data store 330. The key may be queried from the key data store 330 to obtain the financial services data 340 or a pointer or location of the financial services data 340. The key may be stored in a manner associated with other keys, or identifiers in order to provide traceability and genealogy of the processed medical receivables data 305, 307. For example, the generated key may be associated with a key, index, or pointer to the originally received claim and/or payment data, the parsed claim and/or payment data, and the matched claim and payment data. As such, the key generated by the key generator 328 may be considered a master key that provides access to other versions of the data 305, 307.

The interface 322 of the present invention may comprise any suitable means and mechanisms for interfacing or communicating the financial services data 340. In one embodiment, the interface 322 is used to communicate the financial services data 340 to a financial service provider 275 accessible via a network 204. In some embodiments, the interface 322 is a network interface mechanism to transmit network packets comprising the data 340 via the network 204. In other embodiments, the interface 322 is an application, program, process, service, or task constructed to transmit or provide the data 340 in electronic form. In one embodiment, the interface 322 may provide the data 340 via a fax or phone line transmission, while in other embodiments, the data 340 may be transmitted wirelessly. In some embodiments, the interface may be a custom interface to integrate with an application, system, or computer of a financial services provider 275, for example, via a web service interface, or via an application programming interface (API).

The financial services data 340 of the present invention may comprise any processed form of the claim data 307 and/or payment data 305. In one embodiment, the financial services data 340 comprises the claim data 307 without the private information 310 and with a predictive value assigned to a service identified by the claim data 307. In another embodiment, the financial services data 340 comprises a combination of the claim data 307 and payment data 305 without the private information 310, 310′ and with a predictive value assigned to a service identified by the claim data 307 and/or payment data 305. In other embodiments, the financial services data 340 may include the private information 310, 310′. In further embodiments, the financial services data 340 may comprise any portion of the claim data 307, any portion of the payment data 305, or any combination of portions of the claim data 307 and the payment data 305. Additionally, the receivables processing system 120 may generate, incorporate, or provide other data in the financial services data 340, such as a key generated from the key generator 328 or data from any storage or database.

As will be discussed in further detail below in conjunction with the financial services domain processing system 122 of the present invention, the financial services data 340 may be further processed for a specific financial domain, and may be used as a component or element of a financial instrument. For example, the financial services data 340 may identify an asset with a closely approximated value, i.e., receivables assigned a predictive value. The financial services domain processing system of the present invention provides an asset receptacle and securitization conduit by which a financial instrument is created from the qualified asset identified via the financial services data 340.

The claim data store 316, payment data store 318, predictive value data store 324, matched pair data store 326, and key data store 330 may comprise any type and/or form of storage capable of storing data and information in practicing the operations of the present invention described herein. Any of the storages 316, 318, 324, 326, and 330 may comprise a file, a directory, a database, a data structure or object in memory, or any other storage or memory element or location. In one embodiment, the storages 316, 318, 324, 326, and 330 may comprise one or more tables of one or more databases, and may share the same database or be implemented in the separate databases.

Referring to FIGS. 3B-3D, the operations and functions of the illustrative embodiment of the receivables processing system 120 depicted in FIG. 3A will be discussed. FIGS. 3C and 3D depict an illustrative method 350 and method 370 respectively for practicing the operations of the present invention, and FIG. 3B provides an illustrative environment 302 for performing the steps of the method 350 in view of the structure of the receivables processing system 120.

Referring now to FIGS. 3B and 3C, illustrative method 350 is directed towards processing the claim data 307 to provide financial services data 340 having a qualified financial value for a service related to a claim, such as a health care related service. In brief overview, at step 352, claim data 307 is received by the receivables processing system 120, and at step 354, the claim information is parsed and data elements determined to uniquely identify the claim. Furthermore, the private information 310 may be removed from the claim data 307 or encrypted to keep private. At step 356, the parsed data 308 is stored to the claim data store 316. At step 358, a predictive financial value from the predictive value data store 324 is generated and assigned to the identified service of the parsed claim data 308. At step 360, a master key is assigned to the parsed data 308 having a predictive value to associate with and form the financial services data 340. The master key is generated by the key generator 328 and stored to the key data store 330. At step 362, the financial services data 340 is provided with the key to a financial services provider 275.

In further detail, at step 352 of illustrative method 350, data having claim information is received by the receivables processing system 120, for example, by the receiver 312. As illustrated in FIG. 3B, the claim data 307 may include an electronic HIPAA data or transaction set provided by a health care provider 120. The claim data 307 may be provided directly by the health care provider 120 or via an intermediary or clearinghouse 230. In one embodiment, the claim data 307 comprises private information 310 and is communicated securely over a network 204 via a firewall 205a. In another embodiment, the claim data 307 is communicated via an EDI transaction to the hosted service provider 240 executing the receivables processing system 120.

At step 354, the claim data 307 is parsed to identify one or more elements represented by the data and to form a parsed or processed version of the data 308. For example, as illustrated in environment 302 of FIG. 3B, elements A, B, C, and D of the claim data 307 may be identified and parsed out. In one embodiment, one or more of these elements may represent the private information 310, which may be desired to be removed or processed and stored separately from other non-private data. In some embodiments, the one or more elements representing private information 310 are identified and encrypted, and in other embodiments, may be processed with the other portion of the claim data 307 in an encrypted form. In another embodiment, one or more of these elements, such as elements A, B, and C may provide in combination a unique identification of the claim data 307. Additionally, one or more of these elements may represent or identify a service of the claim, such as a health care service. In view of the exemplary embodiment of a HIPAA 837 claim data 307, one or more of these elements may represent any item in the HIPAA 837 transaction implementation.

At step 356, the illustrative method 350 stores the processed claim data 308 to a claim data store 316. The processed claim data 308 may be stored in a table of a database wherein the elements A, B, C, and D as illustrated in environment 302 are fields of a record, and furthermore, may be used as keys or an index to the record. In one embodiment, any of the parsed elements A, B, C or D identifying health information of an individual or considered private information 310 may be removed and not stored to the claim data store 316 with the other data of the claim 307. In some embodiments, a key is associated with the processed data 308 and stored with the processed data 308. Additionally, at step 356, a copy of the originally received claim data 307 may also be stored in the claim data store 316, and may be associated with the stored processed claim data 308. The original claim data 307 may be associated with a key and stored in the claim data store 316. This key may be the same key as the processed claim data 308 or a different key. In the case of a different key, the key for the original claim data 307 may be associated with the key for the processed claim data 308. In some embodiments, the key for the claim data 307 and/or,processed data 308 is generated by the key generator 322.

The illustrative method 350 at step 358 generates a predictive financial value for a service identified via the processed claim data 308. For example, as illustrated in environment 302, element D may identify a service, such as a health care service of a HIPAA Form 837. Using the service information, the predictive value generator 322 generates a financial value for the service. In one embodiment, the predictive value generator 322 uses the service information, e.g., element D, as an input to a look-up table of the predictive value data store 324 to obtain a financial value. In another embodiment, the predictive value generator 322 uses the service information to query the predictive value data store 324 for a financial value. Additionally, the predictive value generator 322 may use other parsed elements, such as illustrative elements A, B, and/or C of data 308 to query the predictive value data store 324. For example, these elements may identify a provider 210, payer 220, and a service type or category.

At step 360 of the illustrative method 350, a master key is generated to assign to the financial services data 340 formed via the processed data 308. In one embodiment, the master key is generated by the key generator 328 and associated with the processed data 308. In some embodiments, the master key is associated with the key for the processed data 308 and/or the key for the claim data 307. As such, the master key provides a link to the original and processed versions of the claim data 307. The generated and assigned master key may be stored in the master key data store 330. Additionally, the master key may be stored along and in association with the financial services data 340.

At illustrative step 362, the financial services data 340 is provided by the receivables processing system 120. The financial services data 340 may be provided via a firewall 205b and a financial services interface 322 to a financial services provider 275. For example, the financial services data 340 may be communicated via the network 204. In one embodiment, the financial services data 340 is provided without the key. In another embodiment, the key is included in the financial services data 340. For example, the key becomes an element, field, or value in the financial services data 340. In another embodiment, the key may be transmitted separately from the financial services data 340. In other embodiments, the key is provided to the financial services provider 275. Then, the financial services provider 275 may present the key to the receivables processing system 120 to obtain the financial services data 340. In some embodiments, the receivables processing system 120 can determine the key from uniquely identifying elements of the financial services data 340. In one embodiment, the financial services data 340 may have a first identifier that is associated with a second identifier associated with the key. For example, the receivables data 305 may have an invoice identifier of “Company XYZ Invoice 304” and the financial services data 340 may include a different but associated invoice identifier, such as, for example, “Invoice 1001” . As such, the receivables processing system 120 recognizes that “Invoice 1001” provided in the financial services data 340 corresponds to the receivables data identified by “Company XYZ Invoice 304.” One ordinarily skilled in the art will recognize and appreciate the various ways the financial services data 340 may be associated with or provides a means to identify the key, indirectly or otherwise.

Referring now to FIGS. 3B and 3D, illustrative method 370 is directed towards processing the payment data 305 to match payment information with corresponding claim data 307, such as claim data 307 processed via illustrative method 350 discussed above. In brief overview of illustrative method 370, at step 372, payment data 305 is received by the receivables processing system 120, and the data is parsed to determine any uniquely identifying elements, and in some embodiments, to remove any private information 310′. At step 376, the parsed payment data 305 is stored in the payment data store 318, such as a database. At step 378, the payment data 305 is compared to the received and processed claim data 307 or 308 to determine if there is a match. If the payment data 305 does not correspond to any received claims 307, then the receivables processing system 120 waits to process the next set of received payment data 305 at step 372. If the payment data 305 corresponds to a received claim 307, then at step 380, the matched claim and payment data is stored to the matched pair data store 326. At step 382, payment information from the payment data 305 regarding payment or the financial value of a service is stored to the predictive value data store 324. Any statistical calculations, such as averages or deviation may be calculated to provide predictive financial value data in the predictive value data store 324. At step 384, the matched pair data may also be associated with a key such that the matched claim and payment data may be associated with the financial services data 340 provided by the present invention.

In further detail, at step 372 of illustrative method 370, data comprising payment information is received by the receivables processing system 120, for example, by the receiver 312. As illustrated in FIG. 3B, the payment data 305 may comprise an electronic HIPAA 305 data or transaction set provided by a health care provider 120. The payment data 305 may be provided directly by the payer 120 or via an intermediary or clearinghouse 230. In one embodiment, the payment data 305 comprises private information 310′ and is communicated securely over a network 204 via a firewall 205a. In another embodiment, the payment data 305 is communicated via an EDI transaction to the hosted service provider 240 executing the receivables processing system 120. In some embodiments, the payment data 305 represent payments for multiple claims from the same or different individuals.

At step 374, the payment data 307 is parsed to identify one or more elements represented by the data and to form a parsed or processed version of the data 306a-306b. For example, as illustrated in environment 302 of FIG. 3B, elements A, B, C, and D of the payment data 305 may be identified and parsed out to form processed data sets 306a-306d. For example, data set 306a may represent payment for a first claim; 306b, payment for a second claim; 306c, payment for a third claim; and 306d, payment for a fourth claim. In one embodiment, one or more of these elements may represent the private information 310′, which may be desired to be removed or processed and stored separately from other non-private data. In some embodiments, the one or more elements representing private information 310′ are identified and encrypted, and in other embodiments, may be processed with the other portion of the payment data 305 in an encrypted form. In another embodiment, one or more of these elements, such as elements A, B, and C may provide in combination a unique identification of a payment for a claim. Additionally, one or more of these elements may represent or identify a service of the claim, such as a health care service. In view of the exemplary embodiment of a HIPAA 835 payment data 305, one or more of these elements may represent any item in the HIPAA 835 transaction implementation.

At step 376, the illustrative method 370 stores the processed payment data 306a-306d to a payment data store 318. The processed payment data 306a-306d may be stored in a table of a database wherein the elements A, B, C, and D as illustrated in environment 302 are fields of a record, and furthermore, may be used as keys or an index to the record. In one embodiment, any of the parsed elements A, B, C or D identifying health information of an individual or considered private information 310′ may be removed and not stored to the payment data store 318 with the other data of the payment data 306. In some embodiments, one or more keys are associated and stored with the processed payment data 306a-306d. Additionally, at step 376, a copy of the originally received payment data 305 may also be stored in the payment data store 318, and may be associated with the stored processed payment data 306a-306d. The original payment data 305 may be associated with a key and stored in the payment data store 318. This key may be the same key associated with the processed payment data 306a-306d or a different key. In the case of a different key, the key for the original payment data 305 may be associated with the key for the processed payment data 306a-360d. In some embodiments, the key for the claim data 307 and/or processed data 308 is generated by the key generator 322.

At step 378, illustrative method 370 may compare the received and processed payment data 306a-306d to any received and processed claim data 308. In one embodiment, the matching engine 326 compares the unique identifying elements of the payment data 306a-306d, such as elements A, B, C and/or D of processed payment data 306a-306d, with any of the unique identifying elements of the claim data 308, such as elements A, B, C, and/or D as illustrated in FIG. 3B. In some embodiments, the matching engine 326 uses any elements of the processed payment data 306a-306d to query the claim data store 316 for corresponding claim data 308. In one embodiment, step 378 is performed for each of the processed payment data sets 306a, 306b, 306c, and 306d parsed from the received payment data 305. If no matches are found at step 378, the receivables processing system 120 may flag or log an indication of such occurrence by any suitable mechanism. Then, the receivables processing system 120 waits for the next set of payment data 305 to be received.

At step 380, if any matches between processed payment data 306a-306a and processed claim data 308 are found, the matched payment and claim data may be stored in a matched pair data store 326. In one embodiment, the matched payment and claim data may be stored as a collective data set in one or more tables of a database. In another embodiment, the matched payment and claim data may be stored distinctly in the matched pair data store 326, for example, as copies of data from the claim data store 316 and payment data store 318, respectively.

At step 382, any of payment related information from the payment data 305 may be used to provide financial data for the predictive value generator 322 and predictive value data store 324. In one embodiment, the payment data 305 comprises the payment amount for a service. This payment amount may be stored in the predictive value data store 322 in relation to the service, type or category of service, the health service provider 210, and/or payer 220. In some embodiments, the payment amount may be an input to a statistical calculation, such as an average. For example, the cumulative average of the payment for the type or category of service may be determined since the start of collecting such data or for a specific date range, such as the past month, past 6 months, or past year. The cumulative average or any other statistical calculation, for example, standard deviation, variance, etc. may also be stored in the predictive value data store 322.

At step 384, the matched pair data stored in the matched pair data store 326 may be associated with a key, such as the master key generated at step 360 of illustrative method 350. In some embodiments, if the payment data 305 is matched to the claim data 307 at the time the master key is generated, the master key is stored or associated with the matched data in the matched pair data store 326. In other embodiments, the receivables processing system 120 queries the master key data store 230 to determine the master key to be associated with the matched pair data.

In another aspect, the present invention is directed towards a financial services domain processing system 122. As described above, the receivables processing system 120 of the present invention generates financial services data 340 providing an asset with a closely approximated value, i.e., a receivable assigned a predictive value. The receivables processing system 120 separates the representation of a qualified receivables asset 340 from the receivables data 305, 307 that may cause exposure to HIPAA compliance. As will be described in further detail below, the financial services domain processing system 122 of the present invention provides an asset receptacle and securitization conduit by which a financial instrument is created from the qualified asset identified via the financial services data 340 from the receivables processing system 120. As such, the issuer of the financial instrument may be removed from exposure to and compliance with HIPAA regulations, but at the same time, have a securitization conduit that supports and enables the underlying receivables to be used as a qualified asset with a predictive financial value.

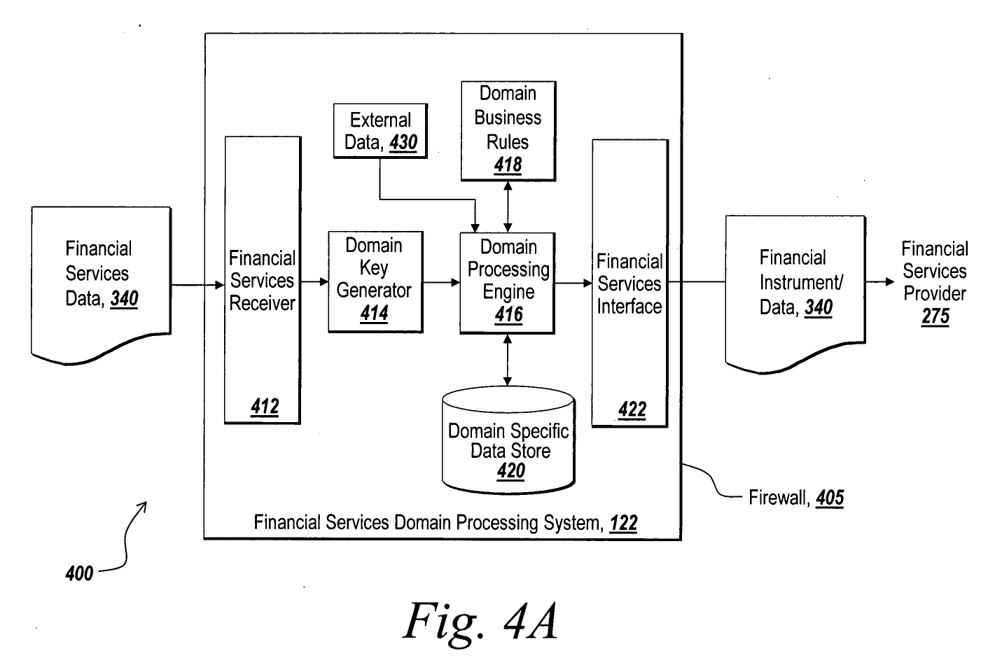

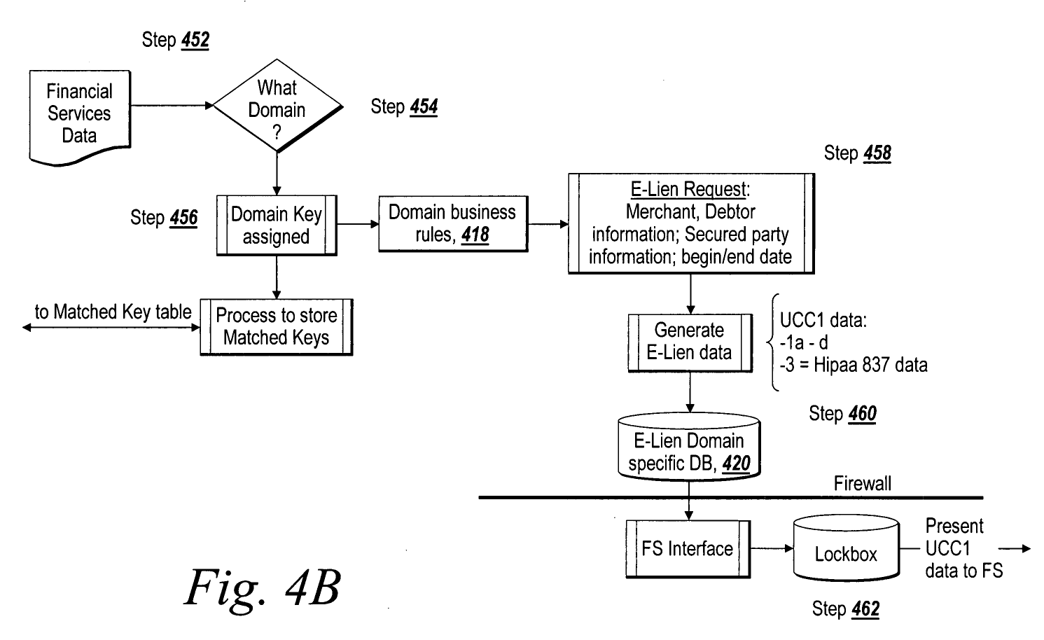

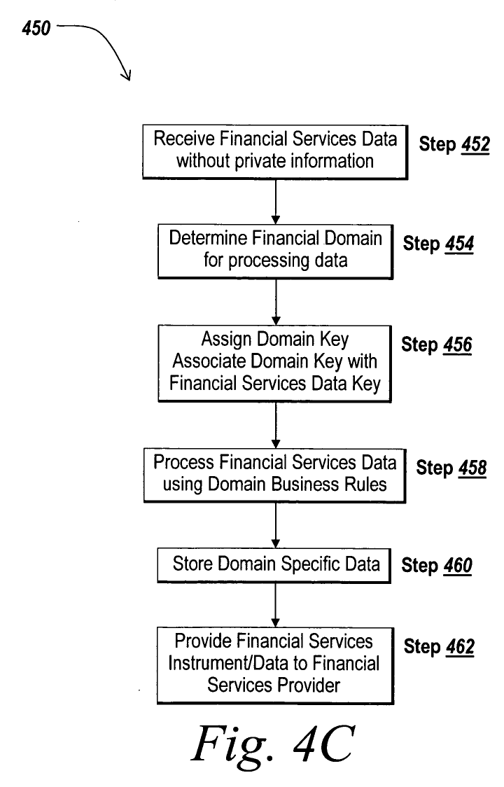

The structure, functions, and operations of the financial services domain processing system 122 of the present invention will be discussed in conjunction with FIGS. 4A-4C. FIG. 4A depicts an illustrative embodiment of the financial services domain processing system 122 while FIGS. 4B and 4C depict methods for practicing an illustrative embodiment of the present invention. Referring now to FIG. 4A, the illustrative environment 400 depicts a financial services domain processing system 122, which receives as input financial services data 340, and provides data for a specific financial instrument 425 as output.

As used herein, the financial instrument 425 provided by the present invention may comprise any type and/or form of financial instrument, such as any financial instrument related to a lien or commercial paper. In one embodiment, a financial instrument packages financial capital in a readily tradeable form. In another embodiment, a financial instrument is a document which has a monetary value or is evidence of a monetary transaction, such as drafts, bills of exchange, checks and promissory notes. In yet another embodiment, a financial instrument is a legally enforceable agreement between two or more parties, expressing a contractual right or a right to the payment of money. As one ordinarily skilled in the art will recognize and appreciate, the diversity of forms of a financial instrument mirrors the diversity of risk that the financial instrument manages. Financial instruments may be categorized according to whether they are securities, derivatives of other instruments, e.g., derivative securities, or so called cash securities. If the financial instrument is a derivative, it may be further categorized depending on whether the instrument is traded as standard derivatives or traded over the counter. Additionally, a financial instrument can also be categorized by asset class depending on whether it is equity based or debt based. If it is a debt security, it may be further categorized into short term or long term. Other types of financial instruments include foreign exchange instruments and repurchase agreements. In one embodiment, the financial instrument 425 is a document to provide securitization of the medical receivables processed by the receivables processing system 120 and received as input by the financial services domain processing system 122 via the financial services data 340.

In brief overview, the financial services domain processing system 122 includes a financial services data receiver 412 in communication with a domain key generator 414. The receiver 412 receives the financial services data 340, such as data provided by the receivables processing system 120, by any suitable interface and communication mechanism. The financial services data 340 may identify one or more health care related services and a financial value for such services. The financial services data 340 may have been derived from medical receivables data, which once included private information 310, 310′ that was removed prior to communication to the financial services domain processing system 122. The domain key generator 414 identifies a domain for processing the financial services data 340, and generates and assigns a domain key to the financial services data 340.

The financial services domain processing system 122 also includes a domain processing engine 416, domain business rules 418, and a domain specific data store 420. The domain processing engine 416 processes the received financial services data 340 by applying domain specific business rules 418 and storing the processed financial data to a domain specific data store 420. The domain processing engine 416 may also use external data 430 when processing the financial services data 340 to insert, modify, combine or aggregate other data to form the financial instrument/data 425. For example, the external data may comprise credit information. The domain processing engine 416 may provide the financial instrument/data 425 via a financial services interface 422 to a financial services provider 275. In one aspect, the domain of the present invention indicates a knowledge domain or area that one is interested in or communicates about. The domain may be considered a particular environment, subject or information area, or a desired area of processing for the present invention.

In further detail, the financial services receiver 412 of the present invention includes any suitable means and mechanisms for receiving the financial services data 340. In some embodiments, the receiver 412 is a socket-based mechanism to receive network packets comprising the data 3340 via a network 204. In other embodiments, the receiver 412 comprises an application, program, library, script, or any type and/or form of executable instructions and may further comprise a service, process, or task constructed to receive or obtain the data 340 in electronic form. In one embodiment, the receiver 412 may receive the data 340 via a fax or phone line transmission, while in other embodiments, the data 340 may be received wirelessly. In other embodiments, the financial services receiver 412 may comprise an Internet based interface, such as a web service or XML interface.

The domain key generator 414 of the present invention comprises any suitable means and mechanisms for determining a domain for the financial services data 340, and for generating and assigning a domain key. In some embodiments, the domain key generator 414 may include an application, program, script, library, process, service, or task of the financial services domain processing system 122. In other embodiments, the domain key generator 414 comprises hardware, or a combination of software and hardware. In one embodiment, the domain key generator 414 determines the domain from parsing and analyzing the content of the financial services data 340. For example, an element of the financial services data 340 may identify a domain. In another example, if the domain key generator 414 determines if the financial services data 340 has one or more elements, then the domain key generator 414 may match the financial services data 340 to a domain.

The domain key generator 414 may include any type and/or form of logic, operations, or functionality for matching a financial services data set 340 with a financial domain. In one embodiment, the domain key generator 414 generates a domain key, which is a pointer to or provides association with a set of templates or business rules for a financial domain, or one or more financial instruments for a domain. The domain key may comprise any combination of letter, numeric, and alpha-numeric characters or symbols to uniquely identify a data set for a specific financial domain processed by the present invention. In one embodiment, the key comprises a database key for storing the data set in a database, such as the domain specific data store 420. In another embodiment, the key comprises an encryption key for securely transmitting the financial instrument data 425. In a further embodiment, the key is a software key assigned to the processed data set. As with the key generator 322 of the medical receivables processing system 122, the domain key generator 414 may store the domain key into a data store. Additionally, the domain key generator 414 may further associate the domain key with any key provided with the financial services data 340, such as the master key generated by the receivables processing system 120 as discussed above.

Although the financial services domain processing system 122 is generally discussed as generating and providing a domain key, the present invention may use sub-domain keys or any hierarchy of one or more domain keys in practicing the operations of the present invention described herein. A first domain key may indicate a top level domain category, and a sub-domain key may indicate a sub-category that logically or otherwise is associated with the top level domain category. For example, the first domain key may indicate or be associated with a category of financial instruments while a sub-domain key indicates or is associated with a specific type of financial instrument in the category.

The domain processing engine 416 includes an application, program, library, script, or any type and/or form of executable instructions and may further comprise a service, process, or task for processing the financial services data 340 for the identified domain. The domain processing engine 416 receives the financial services data 340 as input and provides the financial instrument/data 425 as output. In one embodiment, the financial services data 340 may be pre-processed prior to input to the domain processing engine 416. For example, the financial services domain processing system 122 may also include a parser, such as a parser 312 as illustrated in the medical receivables processing system 122, to identify and extract elements of the financial services data 340.

The financial services data 340 may be modified, re-arranged, combined, aggregated, adapted, composed, or otherwise processed by the domain processing engine 416 to form a desired financial instrument 425 or a desired set of data 425 for a financial instrument. As such, the financial services data 340 comprises an element or component of the financial instrument 425. For example, the financial services data 340 may be processed to provide a Uniform Commercial Code (UCC) instrument 425 to be filed in the appropriate UCC filing authority. The instrument 425 may be filed electronically or printed out and filed in paper format. In some embodiments, the financial services data 340 may be used or combined in processing with external data 430 to form the desired financial instrument 425. The external data 430 may comprise any data related to the desired financial instrument 425, such as any financial, credit, or credit worthiness data of a party to the instrument. For example, the external data 430 may comprise financial and credit data of the health care provider 210 and/or payer 220 for a medical receivables related financial instrument 425. In some embodiments, the external data 430 may comprise any type and/or form of service level agreement or service provider agreement. Those skilled in the art will appreciate a service provider to a securitization conduit may be required to be HIPAA compliant, depending on the type of services provided and their exposure or access level to HIPAA sensitive data. For example, a lockbox service provider, or a collector, will most likely need to be exposed to HIPAA sensitive data in the performance of its duties as the remittance is accompanied by an EOB (explanation of benefits or commensurate), or a collection call will need corroborative data (ex patient ID). However, a credit or liquidity enhance provider need not be exposed to HIPAA sensitive data as such data is irrelevant in order to perform its' services which relate not to specific instruments but rather to the portfolio as a unit. As such a service level agreement or a service provider agreement define the parameters of the service for the benefit of both the service provider and the recipient of the service. In other embodiments, the external data 430 may include any data from related securitization conduit formation processes. The external data 430 may be in any form suitable for input to the domain processing engine 416.

The domain processing engine 416 may use domain specific business rules 418 that indicate how to process the financial services data 340 for the specific domain. The domain specific business rules 418 may indicate how to parse, identify, and extract elements of the financial services data 340 and how to process the elements with or without the external data 430 to form the desired financial instrument 425. In some embodiments, the domain specific business rules 418 may be incorporated or integrated into the domain processing engine 416, such as via logic, operations or functionality of the domain processing engine 416. In other embodiments, the domain specific business rules 418 are configurable and can be specified by a user via any type and/or form of user interface mechanism, such as a graphical user interface, command line interface, or file or database type configuration mechanism.

The domain processing engine 416 stores to the domain specific data store 420 data related to the financial instrument 425 or the processing thereof, and may also store a copy of the received financial services data 340. In one embodiment, the domain processing engine 416 interfaces to the domain specific data store 420 by any suitable database access technology to store the financial instrument data 425 in an organized fashion with identified fields or data elements and corresponding values, such as via a relational database. As with the data stores of the receivables processing system 120, the domain specific data store 420 may comprise any type and/or form of storage capable of storing data and information in practicing the operations of the present invention described herein. The domain specific data store 420 may comprise a file, a directory, a database, a data structure or object in memory, or any other storage or memory element or location. In one embodiment, the domain specific data store 420 may comprise one or more tables of one or more databases.

The financial services interface 422 of the present invention may include any suitable means and mechanisms for interfacing or communicating the financial instrument/data 425, or any components or elements thereof. In one embodiment, the interface 422 is used to communicate the financial instrument/data 425 to a financial service provider 275 accessible via a network 204, and may communicate the financial instrument/data 425 via any type and/or form of firewall 405. In some embodiments, the interface 422 is a network interface mechanism to transmit network packets comprising the data 425 via the network 204. In other embodiments, the interface 422 is an application, program, process, service, or task constructed to transmit or provide the data 425 in electronic form. In one embodiment, the interface 422 may provide the financial instrument 425 via a fax or phone line transmission, while in other embodiments, the financial instrument 425 may be transmitted wirelessly. In some embodiments, the interface may be a custom interface to integrate with an application, system, or computer of a financial services provider 275, for example, via a web service interface, or via an application programming interface (API). In further embodiment, the interface 422 may be a user interface, such as a graphical user interface or web-based interface, for a user to print, email, or download the financial instrument 425.

Referring to FIGS. 4B and 4C, the operations and functions of the illustrative embodiment of the financial services domain processing system 122 depicted in FIG. 4A will be discussed. FIGS. 4B and 4C depict an illustrative method 450 for practicing the operations of the present invention in view of the structure of the financial services domain processing system 122.

In brief overview of illustrative method 450, the financial services domain processing system 122 receives financial services data 340 at step 452. The financial services data 340 may not include any private information 310, 310′, such as individually identifiable health information requiring compliance with HIPAA. At step 454, a financial domain is determined for processing the data 340, and at step 456, a domain key is generated and assigned to the data 340. In one embodiment, the domain key is associated with a key provided by or with the financial services data 340. In another embodiment, the domain key provides an association or a pointer to a set of business rules or templates for providing a financial instrument 425. At step 458, the financial services data 340 is processed by a domain processing engine 416 using domain specific business rules 418, and, at step 460, the resulting domain specific data is stored to a domain specific data store 420. At step 462, the domain processing engine 416 provides a financial instrument or data for a financial instrument 425 via a financial services interface 422. This financial instrument 425 may be provided in electronic form for use by the financial services provider 275.

In further detail, at step 452 of illustrative method 450, financial services data 340 is received by the financial services domain processing system 122, for example, by the financial services receiver 412. The financial services data 430 may comprise an electronic HIPAA 307 data or transaction set provided by a health care provider 120 and processed by the receivables processing system 120 of the present invention. As such, the financial services data 340 may identify one or more health care related services and a corresponding financial value for the service. The financial services data 340 may be provided directly by the health care provider 120 or via an intermediary or clearinghouse 230. In one embodiment, the financial services data 340 is communicated securely over a network 204 and in another embodiment, via a firewall 405. In another embodiment, the financial services data 340 is communicated via a web or Internet-based interface to the hosted service provider 240 executing the financial services domain processing system 122.

At step 454, the domain for the financial services data 340 is determined. The content of the financial services data 430 may be inspected, analyzed, parsed, or processed to identify one or more elements of the data that indicate or identify a desired domain. In some embodiments, the source of the financial services data 340 may be associated with or indicate a specific domain. For example, if the financial services data 340 is transmitted from a specific sender, such as a known network address, the financial services domain process system 122 may therefore know what domain to use. In other embodiments, an instance of the financial services domain process system 122 may be used only to process financial services data 340 for one known domain. For example, the financial services domain processing system 122 may be executed by a financial services provider 275 to handle financial instruments 425 that it may process during the course of business.

At step 456, the illustrative method 450 generates and assigns a domain key to the financial services data 340, and in some embodiments, associates the domain key with the key provided with the financial services data 340. In further embodiments, the illustrative method 450 may generate and assign multiple domain keys, such as a sub-domain key or a second key associated with the first generated domain key. The domain key assigned to the financial services data 340 may indicate an instance of the financial services data, 340 type of financial instrument to be generated, and/or name, type, or category of the domain. In one embodiment, the domain key may be associated with a template or domain business rules 418 for providing the financial instrument 425. In another embodiment, the domain key is associated with the financial instrument 425. In this case, the financial instrument 425 generated by the financial services domain processing system 420 can be traced or linked back to the financial services data 340 provided as input. In one embodiment, the domain key is a software based key. In another embodiment, the domain key comprises an encryption key for providing security for the financial services data 340 and/or the financial instrument 425. In other embodiment, the domain key may be used as a key or index to the domain specific data storage 420.

At step 458, the domain processing engine 416 processes the financial services data 340 in accordance with the business rules 418 and at step 460, stores the processed data to a domain specific data store 420. For example, as illustrated in FIG. 4B, the domain processing engine may generate financial instrument/data 425 for an electronic lien or e-lien request. As such, the financial instrument/data 425 may comprise information regarding the merchant, debtor, secured party, and a begin and end date. In some embodiments, the domain processing engine 416 generates one financial instrument 425 from one set of financial services data 340, and in other embodiments, the domain processing engine 416 generates multiple financial instruments, of the same type or of different types from one or more sets of financial services data 340. In another embodiment, the domain process engine 416 generates one or more financial instruments 415 from a series of one or more financial services data 340 sets, either subsequent to each other or otherwise. In some embodiments, at step 460, the domain key is associated with and stored with the processed data to the domain specific data store 420. Additionally, at step 460, a copy of the originally received financial services data 340 may also be stored in the domain specific data store 420, and may be associated with the stored financial instrument data 425.

The illustrative method 450 at step 462 provides the generated financial instrument 425 via the financial service interface 422. In one embodiment, the financial instrument 425 is provided to a financial services provider 275. In another embodiment, the financial instrument 425 may be provided via a firewall 205 to a financial services provider 275. For example, the financial instrument 425 may be communicated via the network 204. The financial instrument 425 may be provided in any type of electronic form, such as an Acrobat Portable Document File (PDF), a Microsoft Office Document, HyperText MarkUp Language (HTML) file, an XML file or a text document, such as an ASCII file or rich text format file. In some embodiments, the financial instrument 425 may provided via an electronic transaction to another system, and therefore may comprise one or more communications, such as a network packet, having data representing the financial instrument 425 is a manner readable by the other system.

In view of the structure, functions and operations of the receivables processing system and financial services domain processing system as described herein, the present invention provides for an end-to-end solution for automatically generating a financial instrument from receivables data having private information or information requiring compliance with HIPAA. In view of medical receivable data in conjunction with HIPAA, the present invention enables a health care provider to gain more control over the representation of their medical receivables assets and to gain flexibility in the application of these assets with respect to a corresponding financial instrument. The present invention further provides a means by which health care providers can provide information concerning medical receivable assets to financial services providers or other service providers such as pharmaceutical companies, business analysts, educational institutions such that the receiving party is not required to become compliant to HIPAA regulations. Additionally, the present invention provides end-to-end traceability of the receivables data as it is processed into financial services data and then into a financial instrument. This supports the qualification of the financial value of the underlying asset of the financial instrument.

Although the present invention is generally described in relation to health care receivables data for a financial services domain, one ordinarily skilled in the art will recognize and appreciate that the present invention may be practiced with any type and/or form of receivables data and be practiced in any other type of domain. For example, the receivables data may comprise receivables from another industry such as retail, wholesale, consumer or any other type or category of business. Additionally, the receivables data may include information about services, products, or any combination of products and services. In a further example, the domain may comprise a domain for accounting, legal, consulting, or any other service and service provider, or product and product provider.

Many alterations and modifications may be made by those having ordinary skill in the art without departing from the spirit and scope of the invention. Therefore, it must be expressly understood that the illustrated embodiments have been shown only for the purposes of example and should not be taken as limiting the invention, which is defined by the following claims. These claims are to be read as including what they set forth literally and also those equivalent elements which are insubstantially different, even though not identical in other respects to what is shown and described in the above illustrations.

What is claimed is:

1. A method for processing health care related claim data comprising individually identifiable health information to provide a financial related data set, the method comprising the steps of:
receiving a first data set representing a claim to payment for a health care related service, the first data set having individually identifiable health information and a portion identifying a health care related service;
processing the first data set to form a second data set comprising at least the portion of the first data set and free of individually identifiable health information;
generating a predictive financial value for the health care related service; and
associating the predictive financial value with the health care related service in the second data set.

2. The method of claim 1, wherein the first data set comprises an American National Standards Institute Accredited Standards Committee X12 health care claim (837).

3. The method of claim 1, comprising generating a key to identify the second data set.

4. The method of claim 3, comprising providing the second data set with the key to a financial services domain processing server.

5. The method of claim 1, generating the predictive financial value from a history of remittance for one of a type or a category of the health care related service.

6. The method of claim 1, generating the predictive financial value from a history of remittance between a submitter of the claim and a payer of the claim.

7. The method of claim 1, comprising determining one or more data elements of the first data set uniquely identifying the first data set.

8. The method of claim 7, wherein the one or more data elements comprises one of the following: a patient identifier, an insurance company identifier, and a category of service.

9. The method of claim 1, comprising receiving a third data set representing payment information regarding the health care related service.

10. The method of claim 9, wherein the third data set comprises an American National Standards Institute Accredited Standards Committee X12 health care claim payment/advice (835).

11. The method of claim 9, comprising identifying the third data set as providing payment information corresponding to the health care related service of the first data set.

12. The method of claim 1, wherein the first data set comprises an American National Standards Institute Accredited Standards Committee X12 health care claim (837).

13. The method of claim 1, wherein the individually identifiable health information comprises information to be kept private in accordance with the Health Insurance Portability and Accountability Act.

14. A method for processing data for health care related receivables, the method comprising the steps of:
parsing a first data set representing a submission of a health care related claim for a first patient;
determining a first set of identifiers comprising one or more data elements uniquely identifying the first data set;
receiving a second data set representing payment information for one or more health care related claims for one or more patients;
parsing the second data set to determine a second set of identifiers comprising one or more data elements uniquely identifying the second data set; and
comparing the second set of identifiers to the first set of identifiers to determine if the second data set comprises payment information of a health care related claim of the first patient.

15. The method of claim 14, comprising parsing the second data set to determine identifiers on a patient by patient basis.

16. The method of claim 14, wherein the first data set comprises an American National Standards Institute Accredited Standards Committee X12 health care claim (837).

17. The method of claim 14, wherein the second data set comprises an American National Standards Institute Accredited Standards Committee X12 health care claim payment/advice (835).

18. The method of claim 14, comprising, if the second set of identifiers correspond to the first set of identifiers, providing a third data set comprising the first data set and a portion of the second data set related to the first patient.

19. The method of claim 18, comprising assigning a first key to the third data set.

20. The method of claim 19, comprising storing the third data set to a storage location accessible via the first key.

21. The method of claim 14, wherein one of the first data set or the second data set has individually identifiable health information.

22. The method of claim 21, wherein the individually identifiable health information comprises information to be kept private in accordance with the Health Insurance Portability and Accountability Act.

23. The method of claim 14, comprising generating a fourth data set from one of the first data set or the second data set, the fourth data set free of individually identifiable health information.

24. The method of claim 23, comprising assigning a second key to the fourth data set.

25. The method of claim 24, comprising associating the second key with a first key, the first key identifying a third data set comprising the first data set and a portion of the second data set related to the first patient.

26. The method of claim 23, providing the fourth data set and the second key to one of a financial services provider or a financial services processing interface.

27. The method of claim 14, comprising storing payment information corresponding to the health care related claim in a storage location to provide a predictive financial value of remittance for a subsequently submitted health care related claim.

28. A method for processing health care related receivables data into a form for use in a financial domain, the method comprising the steps of:
providing a first data set of health care related receivables data, the first data set having a first key and identifying a service and a financial value for the service;
identifying a financial domain for the first data set;
assigning a first domain key to the first data set;
processing the first data set using a business rule for the identified financial domain; and
generating a second data set from the processed first data set to provide desired financial information for the identified financial domain.

29. The method of claim 28, comprising associating the first domain key with the first key.

30. The method of claim 28, comprising associating a second domain key as a sub-key of the first domain key.

31. The method of claim 28, comprising associating a third data set with the first data set to generate the second data set.

32. The method of claim 31, wherein the third data set comprises one of credit or service agreement related information of a service provider related to the service identified by the first data set.

33. The method of claim 28, comprising presenting the second data set as an element of a financial instrument to a financial services provider.

34. The method of claim 28, wherein the financial value for the service comprises a predictive value of remittance based on one or more of the following: type of service, history of remittance for the type of service, history of remittance between a service provider and payer.

35. The method of claim 27, comprising deriving the first data set from health care related data having individually identifiable health information, and providing the first data set in a form free of individually identifiable health information.

36. A system for processing medical receivables data, the system comprising
a receiver for receiving a first data set representing a claim to payment for a health care related service, the first data set having individually identifiable health information and a portion identifying a health care related service;
a predictive value generator for generating a predictive financial value for the health care related service; and
a processing mechanism for processing the first data set to form a second data set comprising at least the portion of the first data set and free of individually identifiable health information, and associating the predictive financial value with the health care related service in the second data set.

37. The system of claim 36, wherein the first data set comprises an American National Standards Institute Accredited Standards Committee X12 health care claim (837).

38. The system of claim 36, comprising a key generator for generating a key to identify the second data set.

39. The system of claim 38, wherein the second data set with the key is communicated to a financial services domain processing system.

40. The system of claim 36, wherein the predictive value generator generates the predictive financial value from a history of remittance for one of a type or a category of the health care related service.

41. The system of claim 36, wherein the predictive value generator generates the predictive financial value from a history of remittance between a submitter of the claim and a payer of the claim.

42. The system of claim 36, comprising a parser to determine one or more data elements of the first data set uniquely identifying the first data set.

43. The system of claim 42, wherein the one or more data elements comprises one of the following: a patient identifier, an insurance company identifier, and a category of service.

44. The system of claim 36, wherein the receiver receives a third data set representing payment information regarding the health care related service.

45. The system of claim 44, wherein the third data set comprises an American National Standards Institute Accredited Standards Committee X12 health care claim payment/advice (835).

46. The system of claim 45, comprising a matching engine to identify the third data set as providing payment information corresponding to the health care related service of the first data set.

47. The system of claim 36, wherein the first data set comprises an American National Standards Institute Accredited Standards Committee X12 health care claim (837).

48. The system of claim 36, wherein the individually identifiable health information comprises information to be kept private in accordance with the Health Insurance Portability and Accountability Act.

49. A system for processing health care related receivables data into a form for use in a financial domain, the system comprising:
a receiver for receiving a first data set of health care related receivables data, the first data set having a first key and identifying a service and a financial value for the service;
a domain key generator identifying a financial domain for the first data set, and assigning a first domain key to the first data set;
a domain processing engine for processing the first data set using a business rule for the identified financial domain, and generating a second data set from the processed first data set to provide desired financial information for the identified financial domain.

50. The system of claim 49, wherein the domain key generator associates the first domain key with the first key.

51. The system of claim 49, wherein the domain key generator associates with the first data set a second domain key as a sub-key of the first domain key.

52. The system of claim 49, wherein the domain processing engine uses a third data set with the first data set to generate the second data set.

53. The system of claim 52, wherein the third data set comprises one of credit or service agreement related information of a service provider related to the service identified by the first data set.

54. The system of claim 49, comprising a financial services interface to communicate the second data set as an element of a financial instrument to a financial services provider.

55. The system of claim 49 wherein the financial value for the service comprises a predictive value of remittance based on one or more of the following: type of service, history of remittance for the type of service, history of remittance between a service provider and payer.

56. A method for processing receivables data into a financial instrument, the method comprising the steps of:
providing receivables data comprising one or more items to be assigned a value;
generating a financial value to assign to the one or more items;
generating financial services data comprising the one or more items and the financial value assigned to the one or more items;
identifying a financial domain for the financial services data;
processing the financial services data using a business rule for the identified financial domain, the business rule identifying a financial instrument to be generated from the financial services data; and
providing the financial instrument from the processed financial services data.

57. The method of claim 56, wherein the receivables data comprises medical receivables.

58. The method of claim 56, wherein the one or more items comprises one of a service or a product.

59. The method of claim 56, wherein the financial value comprises a qualified value of an asset identified by the one or more items.

60. The method of claim 56, wherein the financial instrument comprises a securitization of an asset represented by the receivables data.

61. The method of claim 56, comprising communicating the financial instrument to a financial services provider.
